(19) United States
(12) Patent Application Publication
(10) Pub. No.: US 2022/0198260 A1
(43) Pub. Date: Jun. 23, 2022

(54) MULTI-LEVEL MULTI-OBJECTIVE AUTOMATED MACHINE LEARNING

(71) Applicant: International Business Machines Corporation, Armonk, NY (US)

(72) Inventors: Chao Xue, Beijing (CN); Lin Dong, Beijing (CN); Xi Xia, Beijing (CN); Zhi Hu Wang, Beijing (CN)

(21) Appl. No.: 17/129,998

(22) Filed: Dec. 22, 2020

(51) Int. Cl. G06N 3/08; G06N 3/04

(52) U.S. Cl. CPC G06N 3/08; G06N 3/0454

(57) ABSTRACT

Multi-level objectives improve efficiency of multi-objective automated machine learning. A hyperband framework is established with a kernel density estimator to shrink the search space based on evaluation of lower-level objectives. A Gaussian prior assumption directly shrinks the search space to find a main objective.

### BACKGROUND

The present invention relates generally to the field of machine learning, and more particularly to neural information processing systems.

Machine learning is a subset of augmented intelligence focused on the study of computer algorithms that improve automatically through experience. The computer algorithms used in machine learning build a mathematical model based on sample data, known as “training data,” to make predictions and/or decisions without being explicitly programmed to do so.

Neural architecture search (NAS) is a algorithm developed for assembling a neural network architecture to suit a particular applications including: (i) image and video recognition; (ii) recommender systems; (iii) image classification; (iv) medical image analysis; (v) natural language processing, and/or (vi) financial time series. Typically, an NAS algorithm begins with the defining a set of “building blocks” that are then sampled by a controller Recurrent Neural Network (RNN) and assembled into a customized neural architecture. The customized architecture is trained to convergence to obtain a specified accuracy on a training validation dataset. Upon completion, the RNN is updated with the resulting accuracies for use by the RNN when generating another customized neural architecture.

Automated machine learning is the process of automating the process of applying machine learning to real-world problems. The process considers machine learning from the raw dataset to the deployable machine learning model. A high degree of automation available to developers allows non-experts to make use of machine learning models and techniques. Commercial examples of automated machine learning are AutoML and AutoKeras. (Note: the terms “AUTOML” and “AUTOKERAS” may be subject to trademark rights in various jurisdictions throughout the world and are used here only in reference to the products or services properly denominated by the marks to the extent that such trademark rights may exist.)

According to probability theory and statistics, a Gaussian process is a collection of random variables indexed by time or space. Every finite collection of the random variables has a multivariate normal distribution. This assumes that every finite linear combination of the variables is normally distributed. The distribution of a Gaussian process is the joint distribution of all random variables. Essentially, it is a distribution over functions with a continuous domain such as time and space.

A machine-learning algorithm that involves a Gaussian process typically uses lazy learning along with a measure of the similarity between points to predict the value for an unseen point from training data. The prediction is not only an estimate for the unseen point, but it also includes uncertainty information, so it is a one-dimensional Gaussian distribution. For multi-output predictions, multivariate Gaussian processes are used, for which the multivariate Gaussian distribution is the marginal distribution at each point.

Gaussian processes are also used in statistical modeling, which benefits from properties inherited from the normal distribution. If a random process is modeled as a Gaussian process, the distributions of various derived quantities can be obtained explicitly. The obtained quantities may include: (i) the average value of the process over a range of times; and (ii) the error in estimating the average using sample values at a small set of times. Approximation methods have been developed that retain good accuracy while drastically reducing computation time.

Pareto efficiency involves a situation where no preference criterion can be made better off without making at least one preference criterion worse off. For a given system, the Pareto frontier (also known as Pareto set and Pareto front) is the set of parameterizations or allocations that are all Pareto efficient. By the Pareto front yielding all of the potentially optimal solutions, a designer can make focused tradeoffs within the constrained set of parameters represented by the Pareto front rather than considering the full ranges of parameters.

### SUMMARY

In one aspect of the present invention, a method, a computer program product, and a system includes: (i) determining an upper-level objective and a set of lower-level objectives for optimized solution using a CNN model; (ii) determining hyperparameter configurations of the upper-level objective and the set of lower-level objectives for use by a hyperband framework to perform a neural architecture search (NAS); (iii) finding, within a first search space, a set of candidate CNN models while performing the NAS; (iv) training the set of candidate CNN models using a training dataset; (v) estimate conditional probability density distribution of solution values of the upper-level objective and the set of lower-level objectives; (vi) selecting a candidate CNN model having a maximum pareto optimal solution; and (vii) training the candidate CNN model to convergence on a validation dataset.

Another aspect of the present invention includes applying additional constraints to a first lower-level objective to shrink the first search space.

Another aspect of the present invention includes determining pareto optimal solutions for each candidate CNN model.

Another aspect of the present invention includes deploying the candidate CNN model by a mobile device.

Another aspect of the present invention includes calculating the density using a Parzen kernel density estimator in order to estimate the conditional probability density distribution.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system; and

FIG. 4 is a block diagram view of a second embodiment of a system according to the present invention.

### DETAILED DESCRIPTION

Multi-level objectives improve efficiency of multi-objective automated machine learning. A hyperband framework is established with a kernel density estimator to shrink the search space based on evaluation of lower-level objectives. A Gaussian prior assumption directly shrinks the search space to find a main objective.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

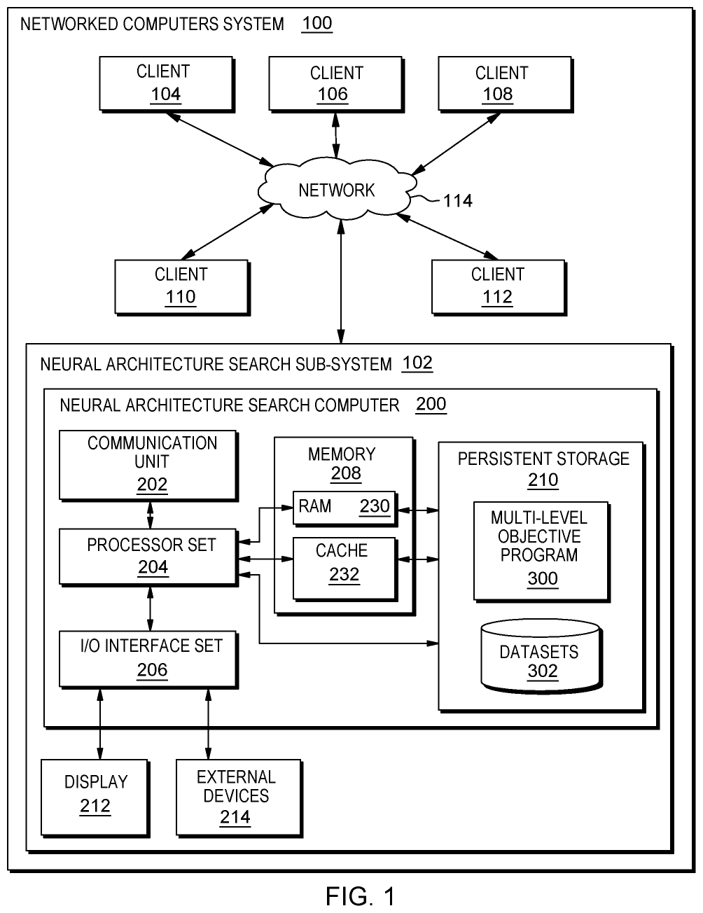

The present invention will now be described in detail with reference to the Figures. FIG. 1 is a functional block diagram illustrating various portions of networked computers system 100, in accordance with one embodiment of the present invention, including: neural architecture search (NAS) sub-system 102; client sub-systems 104, 106, 108, 110, 112; communication network 114; NAS computer 200; communication unit 202; processor set 204; input/output (I/O) interface set 206; memory device 208; persistent storage device 210; display device 212; external device set 214; random access memory (RAM) devices 230; cache memory device 232; multi-level objective program 300; and training/validation datasets store 302.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Multi-level objective program 300 operates to design a convolutional neural network (CNN) model. Particularly, for mobile devices where size and speed are critical as well as accuracy. A neural architecture search (NAS) is performed to build a CNN model to fit a particular problem defined by multiple objectives in a multi-level hierarchy based on hyperparameters for various conditions and/or constraints. Conditional probability density distribution is estimated within a hyperband framework with random generation techniques combined with a gaussian prior assumption to directly shrink the search space based on evaluation of lower level objectives.

NAS algorithms search for CNN models where model hyperparameters, often just referred to as parameters, are used training, validation, and testing phases. Hyperparameters are the parts of the machine learning that must be set manually and tuned. When a machine learning algorithm is tuned for a specific problem, such as when using a grid architecture search or a random architecture search, the hyperparameters are tuned in order to discover which hyperparameters result in the most skillful predictions. Hyperparameter optimization is computationally very costly for neural architectures searches. Hyperband tuning relies on random search tuning. (Note: the term “HYPERBAND” may be subject to trademark rights in various jurisdictions throughout the world and are used here only in reference to the products or services properly denominated by the marks to the extent that such trademark rights may exist.)

Search strategies or tuning strategies used in NAS include: (i) Genetic Algorithm; (ii) Grid search; (iii) Random search; (iv) Bayesian optimization; (v) Reinforcement learning; (vi) DARTS; (vii) Pareto Oriented Method; (viii) Differential method; (ix) hyperband; (x) tree-structured Pareto estimator (TPE); (xi) sequential model-based optimization (SMAC); and (xii) network morphism.

Some embodiments of the present invention recognize the following facts, potential problems and/or potential areas for improvement with respect to the current state of the art: (i) choosing a proper neural network architecture and identifying a good set of parameters are very critical, need experts experience and human labor; (ii) there is little work being done in the area of search space exploration; (iii) convolutional neural networks (CNN) models for mobile devices need to be small and fast, yet still accurate; (iv) a small CNN model is one having a small model size; (v) a fast CNN model is a achieved with a short inference latency; (vi) an accurate CNN model is achieved with good model performance; and/or (vii) there are no NAS methods that deal with multi-objective automated machine learning.

The following equation provides multiple Pareto optimal solutions where x1 and x2 are optimized solutions:

$$\begin{matrix}{max}_{m} = {x}_{1} ( m ) * {[ \frac{{x}_{2} ( m )}{{x}_{2} ( {m}_{bl} )} ]}^{ω} & ( 1 ) \\ ω = \{ \begin{matrix}α , & {x}_{2} ( m ) \leq {x}_{2} ( {m}_{bl} ) \\ β , & otherwise\end{matrix} \} & ( 2 )\end{matrix}$$

Applying the above equation to determine the conditional probability density distribution results in the following equation:

$${E}_{{x}_{1} \vert {x}_{2}} [ {x}_{1} ( m ) * {( \frac{{x}_{2} ( m )}{{x}_{2} ( {m}_{bl} )} )}^{ω} ] = {\int }_{0}^{1} {x}_{1} ( m ) * {( \frac{{x}_{2} ( m )}{{x}_{2} ( {m}_{bl} )} )}^{ω} * p ( {x}_{1} \vert {x}_{2} ) {dx}_{1} \qquad ( 3 )$$

The density p(x₁|x₂) can be computed by a density estimator, such as KDE 404 of FIG. 4. Accordingly, the following equation is generated:

$$\begin{matrix}{E}_{{x}_{1} \vert {x}_{2}} [ {x}_{1} ( m ) * {( \frac{{x}_{2} ( m )}{{x}_{2} ( {m}_{bl} )} )}^{ω} ] = {( \frac{{x}_{2} ( m )}{{x}_{2} ( {m}_{bl} )} )}^{ω} * {E}_{{x}_{1} \vert {x}_{2}} [ {x}_{1} ] & \end{matrix} \qquad ( 4 )$$

According to some embodiments of the present invention, sometimes adding some constraints of other objectives will improve reaching the main objective. This is possible because after shrinking the search space with a Gaussian prior assumption, there is more chance to find a reliable main objective.

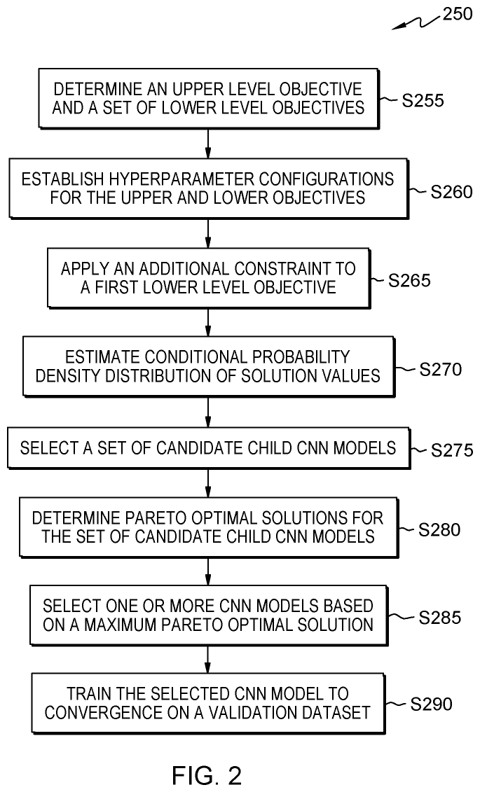

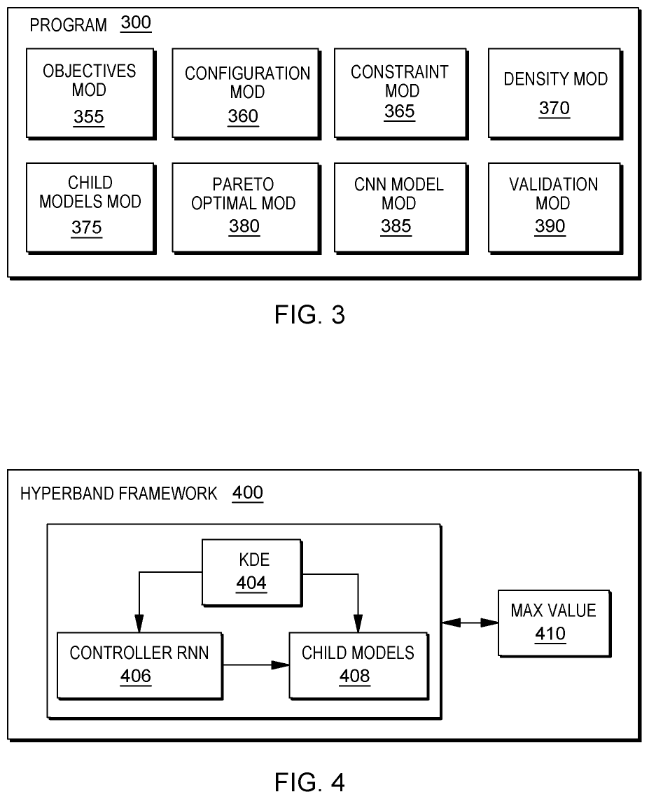

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where objectives module (“mod”) 355 determines an upper level objective and a set of lower level objectives for optimized solution when using a convolutional neural network (CNN). For a given multi-level problem, an upper level objective is determined along with one or more lower level objectives. In this example, there is a bi-objective problem where the lower level objectives are nested, or embedded, within the upper level objective. Alternatively, the problem being addressed is a bi-level problem where the upper level objective is a primary objective to be optimized in view of a set of lower level objectives. For each objective there is at least one variable to be solved for a target condition.

Processing proceeds to step S260, where variables mod 360 establishes hyperparameter configurations for the upper and lower objectives. In the example, the hyperparameter configurations are determined by Gaussian prior assumptions to directly shrink the search space. Alternatively, an evolutionary algorithm determines the hyperparameters. The hyperparameter configurations are developed for use by a hyperband framework to perform The search space shrinks based on evaluation of other lower level objectives to reach a best value of the upper level objective. Some embodiments of the present invention shrink the search space via network morphisms to preserve the network function.

Processing proceeds to step S265, where constraint mod 365 applies an additional constraint to a lower level objective. The constraints to be added may be interpreted by a probability density distribution. Lower-level constraints may be evaluated to directly shrink the search space, which better supports the context of a multi-objective neural architecture search.

Processing proceeds to step S270, where density mod 370 estimates conditional probability density distribution of solution values of the upper-level and the lower level objectives for the neural architecture search (NAS). As described in the above-recited equations, Parzen kernel density estimators (KDE) are employed to approximate the densities for estimating the conditional probability density distribution. Each objective has at least one variable for which hyperparameters are set. In this example, child convolutional neural network (CNN) models are generated by hyperparameter configurations for objectives based on Gaussian priors to shrink the search space instead of approximating the entire Pareto frontier. Alternatively, the child models are generated using an evolutionary algorithm.

The child CNN models are trained using a training dataset. Performance during training is recorded. According to conditional probability density distribution of solution values certain child CNN models are further processed as candidate CNN models.

Processing proceeds to step S275, where child models mod 375 selects a set of child CNN models. Child CNN models generated via the NAS process and trained via training datasets. The selected child CNN models may be submitted for validation testing according to individual performance. The selected child models are among the top-k models found in the NAS. The selected child CNN models are identified as candidate CNN models.

Processing proceeds to step S280, where pareto optimal mod 380 determines pareto optimal solutions for each candidate CNN model. For each candidate CNN model, training datasets are introduced to determine pareto optimal solutions. The maximum pareto optimal solution is the basis for selection of one or more candidate CNN models to be validated and tested.

Processing proceeds to step S285, where CNN model mod 385 selects a CNN model having a maximum pareto optimal value. The maximum pareto optimal value is identified and the corresponding candidate CNN model us selected. Alternatively, two CNN models are selected based on the pareto optimal solutions.

Processing ends at step S290, where validation mod 390 trains the selected CNN model to convergence on a validation dataset. The validation dataset is held back from the training dataset for use in validation. This validation step supports tuning of the model hyperparameters that, in some embodiments, are based on Gaussian prior assumptions. Further, some embodiments of the present invention perform testing using additional held-back datasets for testing purposes.

Further embodiments of the present invention are discussed with reference to FIG. 4 and in the paragraphs that follow.

FIG. 4 shows hyperband framework 400 according to some embodiments of the present invention. The hyperband framework uses Parzen kernel density estimator (KDE) 404 to compute the density p(x₁|x₂). Optimizing solution xl is introduced to controller recurrent neural network (RNN) 406. Random generation of convolutional neural network (CNN) models provides the basis for selecting child models for further training. Some embodiments of the present invention identify child models based on a top-k selection process. Child models module 408 performs validation of the models by introducing optimizing solution x2. Maximum value module 410 identifies the child model producing the maximum pareto-optimized value. The identified child model is selected as the CNN model for use in designated mobile device applications.

Some embodiments of the present invention are directed to a method including steps wherein multi-level objectives are differed based on evaluation efforts; the main objective is chosen by the objective with most evaluation resources; adding a constraint of other lower level objectives operate to improve the main, or upper-level, objective; and shrinking the search space based on the evaluation of other objectives in order to find a valid and/or reliable main objective.

Some embodiments of the present invention are directed to multi-level multi-objective AutoML by shrinking the search space based on the evaluation of other objectives in order to find a good main objective. Further, in some embodiments, the multi-level objectives are varied according to evaluation efforts.

Some embodiments of the present invention use low-level objectives to estimate the high-level objectives. In some embodiments the estimated low-level objectives are arrived at via a Gaussian prior assumption.

Some embodiments of the present invention use a Gaussian prior assumption to directly shrink to search space based on the evaluation of lower-level objectives in order to find a good main objective.

Some embodiments of the present invention may include one, or more, of the following features, characteristics and/or advantages: (i) automated machine learning enables searching for a best model automatically without substantial human intervention; (ii) takes advantage of multi-level objective processing to drive an efficient multi-objective neural architecture search process; (iii) utilizes multi-level objectives; and/or (iv) speeds up the multi-objective neural architecture search process.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for designing a convolutional neural network (CNN), the method comprising:
determining an upper-level objective and a set of lower-level objectives for optimized solution using a CNN model;
determining hyperparameter configurations of the upper-level objective and the set of lower-level objectives for use by a hyperband framework to perform a neural architecture search (NAS);
finding, within a first search space, a set of candidate CNN models while performing the NAS;
training the set of candidate CNN models using a training dataset;
estimate conditional probability density distribution of solution values of the upper-level objective and the set of lower-level objectives;
selecting a candidate CNN model having a maximum pareto optimal solution; and
training the candidate CNN model to convergence on a validation dataset.

2. The method of claim 1, further comprising:
applying additional constraints to a first lower-level objective to shrink the first search space.

3. The method of claim 1, further comprising:
determining pareto optimal solutions for each candidate CNN model.

4. The method of claim 1, wherein the estimating the conditional probability density distribution includes:
calculating the density using a Parzen kernel density estimator.

5. The method of claim 1, further comprising:
deploying the candidate CNN model by a mobile device.

6. A computer program product comprising a computer-readable storage medium having a set of instructions stored therein which, when executed by a processor, causes the processor to design a convolutional neural network (CNN) by:
determining an upper-level objective and a set of lower-level objectives for optimized solution using a CNN model;
determining hyperparameter configurations of the upper-level objective and the set of lower-level objectives for use by a hyperband framework to perform a neural architecture search (NAS);
finding, within a first search space, a set of candidate CNN models while performing the NAS;
training the set of candidate CNN models using a training dataset;
estimate conditional probability density distribution of solution values of the upper-level objective and the set of lower-level objectives;
selecting a candidate CNN model having a maximum pareto optimal solution; and
training the candidate CNN model to convergence on a validation dataset.

7. The computer program product of claim 6, the set of instructions, when executed by the processor, further causing the processor to design a convolutional neural network (CNN) by:
applying additional constraints to a first lower-level objective to shrink the first search space.

8. The computer program product of claim 6, the set of instructions, when executed by the processor, further causing the processor to design a convolutional neural network (CNN) by:
determining pareto optimal solutions for each candidate CNN model.

9. The computer program product of claim 6, wherein the estimating the conditional probability density distribution includes:
calculating the density using a Parzen kernel density estimator.

10. The computer program product of claim 6, the set of instructions, when executed by the processor, further causing the processor to design a convolutional neural network (CNN) by:
deploying the candidate CNN model by a mobile device.

11. A computer system for designing a convolutional neural network (CNN), the computer system comprising:
a processor(s) set; and
a computer readable storage medium having program instructions stored therein;
wherein:
the processor set executes the program instructions that cause the processor set to perform a method by:
determining an upper-level objective and a set of lower-level objectives for optimized solution using a CNN model;
determining hyperparameter configurations of the upper-level objective and the set of lower-level objectives for use by a hyperband framework to perform a neural architecture search (NAS);
finding, within a first search space, a set of candidate CNN models while performing the NAS;
training the set of candidate CNN models using a training dataset;
estimate conditional probability density distribution of solution values of the upper-level objective and the set of lower-level objectives;
selecting a candidate CNN model having a maximum pareto optimal solution; and
training the candidate CNN model to convergence on a validation dataset.

12. The computer system of claim 11, further causing the processor set to perform a method by:
applying additional constraints to a first lower-level objective to shrink the first search space.

13. The computer system of claim 11, further causing the processor set to perform a method by:
determining pareto optimal solutions for each candidate CNN model.

14. The computer system of claim 11, wherein the estimating the conditional probability density distribution includes:
calculating the density using a Parzen kernel density estimator.

15. The computer system of claim 11, further causing the processor set to perform a method by:
deploying the candidate CNN model by a mobile device.
